(19) United States
(12) Patent Application Publication
(10) Pub. No.: US 2004/0030869 A1
(43) Pub. Date: Feb. 12, 2004

(54) Method for operating a progammable control device

(76) Inventor: Klaus Spichtinger, Stulln (DE)

Correspondence Address: STAAS & HALSEY LLP, SUITE 700, 1201 NEW YORK AVENUE, N.W., WASHINGTON, DC, 20005, US

(21) Appl. No.: 10/432,366

(22) PCT Filed: Nov. 16, 2001
(86) PCT No.: PCT/DE01/04324

(30) Foreign Application Priority Data
Nov. 22, 2000 (DE) 10057780.6

(51) Int. Cl. G06F 9/44

(52) U.S. Cl. 712/223

(57) ABSTRACT

The method is characterised in that comparison operations (31) which can be evaluated by an evaluation routine (4) can be formulated at the time the programme (8) of the control device (1) is running and in that actions (32, 33) that can also be formulated at the time the programme (8) is running are triggered according to the result of the respective comparison operation (31). This enables the control device (1) to be diagnosed and/or monitored without interrupting its operation.

The invention relates to a method for operating a programmable control device which has a memory and a processing unit, where the memory stores an evaluation routine which can be executed by the processing unit.

A programmable control device is known, by way of example, in the form of a personal computer, in the form of a central processor unit for a “programmable logic controller”, or generally in the form of a “controller” used in various electrical equipment in order to control it. The software determining the control device's behavior is stored in the memory and is executed by the processing unit. The control device is suitable for holding and processing external data and signals and for initiating particular, programmed actions on the basis thereof. This involves, by way of example, performance of a comparison between an input value and a prescribed nominal value, and initiation of a prescribed action on the basis of the result of this comparison. A frequently variable value, such as the nominal value, is in this case normally in the form of an external parameter which can be brought into line with a situation which has altered without changing or updating the software. A condition and an action, on the other hand, are part of the software.

A drawback of these known programmable control devices is that although a condition parameter can be altered without changing or updating the software, this is not possible for the actual condition or for the action which is initiated on the basis of the result of the condition.

The invention is therefore based on the object of specifying a method for operating a programmable control device in which it is also possible to alter the condition (comparison operation below) and/or the action—as a reaction to possible results of the condition—without this requiring that the software be changed or updated. Alterations made thus have a direct effect—at the software's “runtime”—on the behavior of the control device.

The invention achieves this object by means of the features of claim 1. To this end, the programmable controller's memory stores an operand, a comparison operator and a comparison value independently of the evaluation routine which can be executed by the processing unit. In this context, the operand, the comparison value and the comparison operator form a binary comparison operation which delivers either a first or a second result. The first result has an associated first action, and the second result has an associated second action. Execution of the evaluation routine involves evaluation of the binary comparison operation and, on the basis of the result of the comparison operation, performance of either the first or the second action. In principle, however, the invention can also be applied to operations which have more than two results.

A “binary operation” is an operation using precisely two operands, with each operand itself being able to be an operation. One example of a binary operation (in the notation of the programming language C, C++) is the (comparison) operation “a==b” or the (assignment) operation “a=b”, where “a” and “b” are operands for the specific binary operation. On a general basis, a binary operation comprises a first and a second operand (or parameter) and an operation descriptor (or operator) An operation “A+B==C” is also a binary operation. However, this specific binary operation itself contains a binary operation, namely the addition of the two parameters “A”, “B” in an “internal” binary operation, as a first parameter. The result of this internal binary operation is, besides the parameter “C”, the further parameter for the external binary comparison operation.

The binary operation is the most common operation, which means that frequently no distinction is drawn between operation and binary operation as the form of expression. The terms “binary operation” and “operation” are therefore also used synonymously below. In addition to the binary operation, there is also the “unary operation”. This involves just one parameter and one operator. An example of a unary operation is inversion/negation of the operand—“!a”, again in the notation of the programming language C, C++.

Any complex expressions can be composed from binary and unary operations. The possible operations to which the parameters of individual binary operations can be subjected are, by way of example, arithmetic operations such as addition, subtraction, multiplication and division operations, logic operations such as ANDing or ORing, assignment operations (a=b) and comparison operations for comparing the parameters with regard to identity (==), inequality (!=), less than (<), less than or equal to (<=), greater than (>), greater than or equal to (>=), etc.

An operation “a OP1 b”, with OP1 as the comparison operator, is a binary comparison operation. Similarly, “x OP2 y OP1 b”, with OP1 as the comparison operator, is also a binary comparison operation with the internal binary operation “x OP2 y”, where OP2 is an arithmetic operator (+, 31 , ×, /) or a logic operator (AND, OR) (“x OP2 y” is the “internal” operation, since OP1 as the comparison operator has the lowest priority. Thus, by way of example, in “a+b=c”, “a+b” is always performed first before the assignment is made.

The “type” of the result of an operation depends fundamentally on the type of the operand or operands. Thus, the addition, subtraction or multiplication of two natural numbers results in another natural number, while the addition, subtraction or multiplication of a natural number and real number results in a real number. By contrast, regardless of the type of the operands, a binary comparison operation always produces a result of the type [yes, no] (or else [true, false], [satisfied, not satisfied], depending on the description/representation). The reason for this is that if, by way of example, two operands are tested for equality (==), the result of the comparison operation has only the two results “equality”—corresponding to “yes”/“true”/“satisfied”—or “inequality”—corresponding to “no”/“false”/“not satisfied”.

The evaluation routine can be executed by the processing unit. The comparison operation stored independently of the evaluation routine, on the other hand, cannot be executed by the processing unit. The reason for this is that the comparison operation is just a combination of data—namely operand, comparison value and comparison operator—which, although they logically form an operation, do not represent any executable code. By evaluating these data, the evaluation routine permits evaluation of the comparison operation formed thereby.

Since the result of the comparison operation is always taken as a basis for performing either the first or the second action, it is possible to react specifically to the result of the comparison operation. This means that it is possible, by way of example, to monitor the content of a sensitive memory cell in the control device for alterations, e.g. deviations from an expected value. To this end, the operand used is the content of the memory cell which is to be monitored, and the comparison value used is the expected value. The comparison operator used is the operator for comparison with regard to identity. Whenever the evaluation routine is executed, the condition specified by the comparison operation is evaluated. This results in the first action, if the content of the memory cell matches the comparison value, and in the second action, if this identity does not exist. The second action thus indicates the alteration in the memory cell which is to be monitored. The actions relate, by way of example, to the setting or erasure of a memory location or to the turning-on or turning-off of an operating means, e.g. a lamp.

In one expedient refinement, the memory stores a masking value in addition to the operand, the comparison operator and the comparison value. The masking value and the operand are then operands for a masking operation using a masking operator. This internal masking operation is evaluated by the evaluation routine. The result of the masking operation forms the binary comparison operation together with the comparison value and the comparison operator. In line with this refinement, the comparison operation is thus complemented by an internal masking operation. Rather than the content of an entire memory cell, which usually comprises eight or sixteen bits, it is thus possible to monitor individual positions, i.e. individual bits of the memory cell, for example.

To check whether the top bit of an 8-bit memory cell has been set, the memory cell's content is logically ANDed with the binary value “1000 0000”, corresponding to 128 in decimal or 80 in hexadecimal. The operand is thus the content of the memory cell, the masking value is “80” and the logical ANDing is the masking operator. The result of this masking operation is either “80” or “0”, depending on whether the examined bit in the memory cell checked had been set. Finally, the external comparison operation performs the check for inequality with “0”, for example. If the condition for the external comparison operation is satisfied (80≠0), the bit had been set.

In addition to the masking by means of logical ANDing, masking by means of logical ORing or by means of logical exclusive-ORing, for example, is also possible. In another refinement, provision is therefore made for the masking operator also to be stored in the memory for the purpose of unrestricted presetting. The masking operator is taken into account when the masking operation is evaluated by the evaluation routine.

If the comparison operation is coded by the content of a respective operation area stored in the memory, said operation area comprising either at least the operand, the comparison value and the comparison operator or—depending on the embodiment—additionally the masking value, it is possible to organize the parameters for the comparison operation in a specifically addressable memory area—the operation area. To this end, a composed data type can be defined which comprises the fields required for the respective parameters. When this composed data type is used, the memory can be used to store associated parameters in a respective operation area, this implicitly defining the association between said parameters. This simplifies organization and assignment of the parameters. In addition, this allows a first comparison operation to be replaced with a second comparison operation easily and quickly.

In a similar manner to the comparison operation, the initiating action is also specified by parameters stored in the memory. An advantage in this case is that each action, that is to say the first and the second action, is coded by a first and a second action area. Each action area comprises either a secondary action or a combinational logic reference or both a secondary action and a combinational logic reference. In fact, the action area comprises, as a segment of the memory, a position for storing the secondary action or a position for storing the combinational logic reference. To simplify matters, the memory position and the respective content are referred to synonymously below. The action area is used for organizing the parameters (secondary action, combinational logic reference) for an action and simplifies access to associated parameters.

In one advantageous development, the operation area and the first and second action areas in the memory form a cohesively addressable structure, a condition block. The condition block comprises both the parameters for coding the comparison operation and the parameters for coding the first and second actions. The condition block (or a “pointer” to the condition block) can thus be used as a parameter for the evaluation routine. The memory can store a multiplicity of condition blocks. To use another condition block, it is thus merely necessary [lacuna] another parameter, namely the other condition block or its address, to the evaluation routine.

If each action, the first and the second action, comprises initiation of an associated secondary action, it is also possible to prescribe and alter a specific action at runtime. If the first action always prompts a lamp to be turned on and the second action always prompts it to be turned off, for example, the circumstance of whether the condition coded by the comparison operation is satisfied can be seen from the status of this operating means. This is appropriate and useful for the purposes of diagnosis.

To ascertain how often a condition is satisfied during operation of the control device, a technician would need to count the lamp's illumination. If the condition is satisfied a plurality of times in succession, it is not possible to tell how often the condition was actually satisfied if the lamp is permanently illuminated. In addition, counting by the technician is generally prone to error. As a secondary action, provision is therefore made for a counter to be incremented or decremented, for example. If, by way of example, the secondary action prescribed for the first action is the incrementing of a first counter, then the value of this counter can always be used to ascertain how often the condition was satisfied. Other secondary actions are, by way of example, the initiation of an interrupt or trigger.

A permissible specification for a secondary action is expediently also the start address of a program segment, which means that initiation of the secondary action comprises execution of the routine stored in the memory from the indicated start address.

If each action has a respective associated combinational logic reference which is suitable for referencing a condition block by indicating the corresponding address in the memory, and the action comprises evaluation of the combinational logic reference, two or more condition blocks can be logically combined to formulate more complex expressions. This means that comparison operations of the type “(A==B) AND (C==D)” can be shown. The first condition “A==B” is coded by a first condition block. The second condition “C==D” is coded by a second condition block. The two condition blocks are logically combined using the combinational logic reference for that action of the first condition block which is initiated when the condition is satisfied.

For the description below, it will be assumed that the first action is always initiated when the condition is satisfied and that the second action is always initiated when the condition is not satisfied.

To express logical ANDing of two operations using two condition blocks, the first combinational logic reference, the combinational logic reference for the first action of the first condition block, is assigned the address of the second condition block. The second combinational logic reference for the first condition block and the two combinational logic references for the second condition block are set to a value of “0”, for example, which explicitly indicates that there is no logic combination. This is because if the first condition is not satisfied, the expression can never be true on the whole, which means that no further evaluation is necessary.

Accordingly, to express logical ORing of two operations, the combinational logic reference for the second action of the first condition block is assigned the address of the second condition block. All other combinational logic references need to be set to the explicit value.

Advantageously, the first or the second action of each condition block comprises both initiation of the secondary action and evaluation of the combinational logic reference. For complex expressions, it is then possible for the secondary action to be, by way of example, the formation of intermediate results (setting/erasing a memory location) or the reaction (interrupt, trigger) to particular intermediate results.

The method can be used advantageously for a control device for monitoring and/or diagnosis of the data traffic which has a bus port for connection to a bus and is suitable for receiving a telegram via the bus and, upon reception of a telegram, copies at least one data area of the telegram to a reception memory in the memory by virtue of the operand being an element of the reception memory or denoting a position in the reception memory. A condition block's comparison operation thus relates directly or indirectly to a data item in the received telegram. Appropriate expressions thus make it possible to monitor, by way of example, whether a particular data sequence has been received or how many times a particular data sequence is received before a memory cell changes its value. All of these expressions can be formulated and prescribed at the time at which the control device's software is run.

A prerequisite for using this monitoring and diagnosis method is thus merely that the control device has access to the evaluation routine. Execution of the evaluation routine then involves evaluation of the comparison operation for the condition block transferred as a parameter and, on the basis of the result, performance of either the first or the second action in line with the content of the first or second action area of the condition block.

In line with another advantageous refinement, the evaluation routine is hard-coded. The evaluation routine can be hard-coded if it can be formulated such that each comparison operation can always be evaluated by one and the same evaluation routine, regardless of the respective operand or operator. In this context, despite the wide variety of options for formulating the comparison operation, the evaluation routine itself is invariable. The evaluation routine, which is thus static, can be implemented in the form of a user-specific circuit, e.g. an ASIC or an FPGA, using hard coding.

An exemplary embodiment of the invention is explained in more detail below with reference to a drawing, in which:

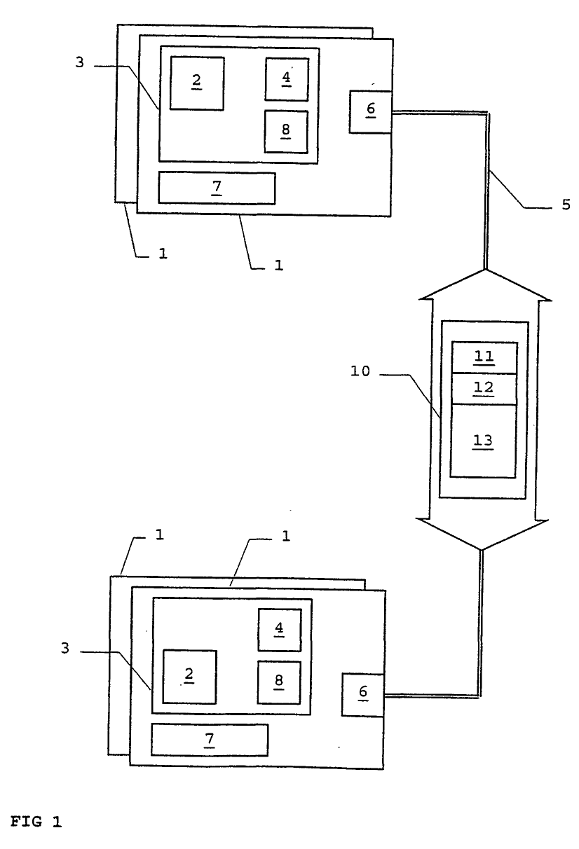

FIG. 1 shows control devices connected to one another by means of a bus so that they can communicate,

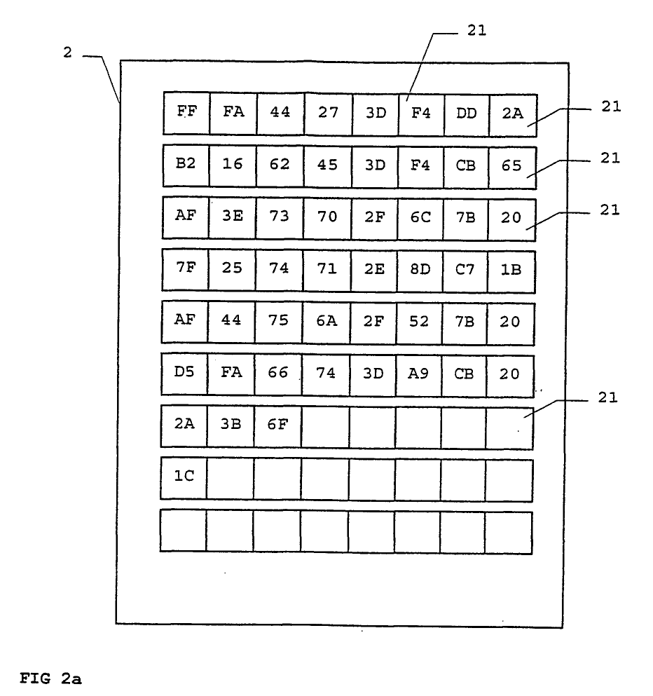

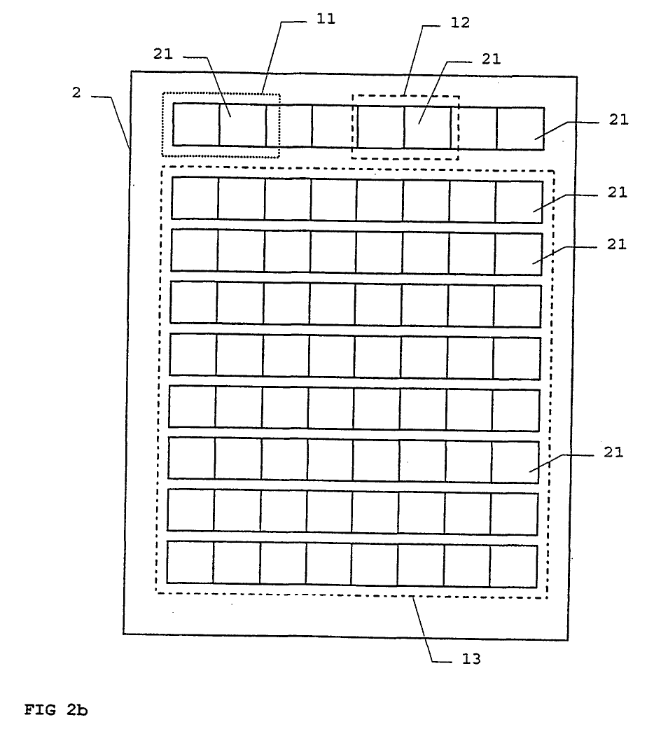

FIGS. 2a and 2b show a reception memory area in the control device,

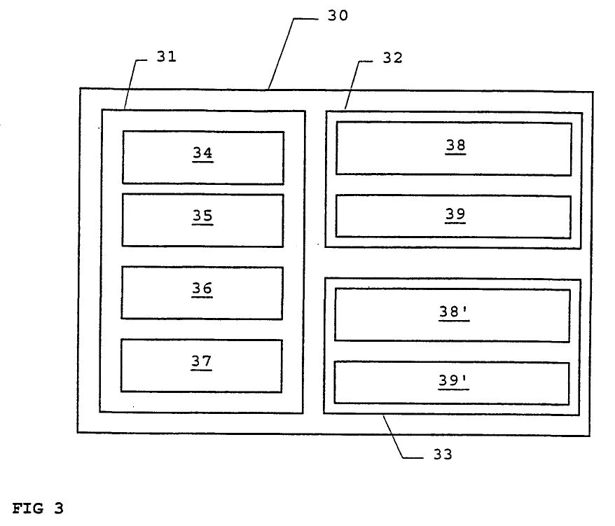

FIG. 3 shows a condition block, and

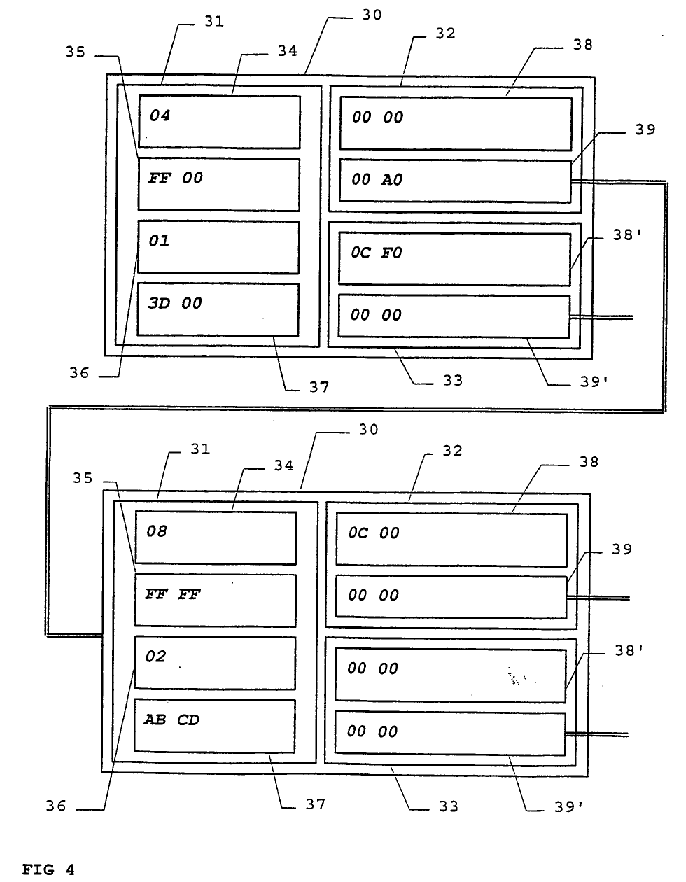

FIG. 4 shows logically combined condition blocks.

FIG. 1 shows a first and a second control device 1 and also further, partially concealed control devices 1, each with a reception memory or a reception memory area 2 which is part of a memory 3. In addition, the memory 3 stores an evaluation routine 4. The control devices 1 are connected to one another by means of a bus 5 in a manner which is known per se such that they can communicate. For connection to the bus 5, each control device 1 has a bus interface 6. In addition, to control the bus 5 (sending, receiving), a processing unit 7 is provided, e.g. a microprocessor or an ASIC. The processing unit 7 can execute the evaluation routine 4.

The memory 3 also stores the firmware/software 8 which allows the control device 1 to control the bus 5 and to engage in the data traffic via the bus 5, under the control of the processing unit 7. The processing unit 7 is provided in order to execute the firmware/software 8. The processing unit 7, the memory 3 and the bus interface 6 are connected to one another by means of an internal bus (not shown), for example, in a manner which is known per se. The first control device 1 is thus suitable for interchanging data 10 with the second control device 1 via the bus 5 (illustrated by the double-headed arrow).

The control device 1 allows, by way of example, connection of a further device (not shown) which does not have its own bus port to the bus 5. By way of example, the control device 1 is also an “intelligent field transmitter” which can be used for automation purposes, however, said intelligent field transmitter containing a bus interface 6 and also affording, by way of example, input/output functionality or processing functionality (counting, control, etc.) for controlling and/or monitoring an external technical process. Both the control device 1 and the electrical equipment with an integrated control device 1 are referred to as communicating parties below.

Data interchange between at least two communicating parties 1 is effected using “telegrams” 10, with one of the communicating parties 1 sending data and at least one other communicating party 1 receiving the transmitted data. The telegram 10 is a structured data packet which has a receiver identifier 11 and a sender identifier 12 and is interchanged between at least two communicating parties 1 on the basis of a protocol which is defined for the bus 5. The receiver identifier 11 is used to indicate that communicating party 1 for which the telegram 10 is intended. In this way, it is possible to send a telegram 10 to a particular communicating party 1 or else—with an appropriate receiver identifier 11—to all communicating parties 1. The sender identifier 12 is used to indicate that communicating party 1 which has sent the telegram 10. In addition to the receiver identifier 11 and the sender identifier 12, the telegram 10 also comprises the actual user data 13.

To receive a telegram 10, each communicating party 1 observes the data traffic on the bus 5 under the control of the processing unit 7. If, in the course of this, a telegram 10 with a receiver identifier 11 determining the respective communicating party 1 to be a receiver is identified, the telegram 10, possibly even just its user data 13, is copied to the reception memory 2. There are also communicating parties 1 which copy all telegrams 10 to the reception memory 2, regardless of the respective receiver identifier 11. The telegram 10 or the user data 13 in the telegram 10 is/are evaluated on the basis of the content of the reception memory 2 in the communicating party 1.

FIG. 2a shows a first illustration of the reception memory 2, which comprises a number of memory cells 21. Each of the memory cells 21 can receive a data item. The terms “data item”—content of a memory cell—and “memory cell” are used synonymously below. Each memory cell 21 has a unique address which can be used to reference the memory cell or its content. The content of the first memory cell 21 (position/address 0) is, by way of example, “FF”, the content of the seventeenth memory cell (position/address 16=10_{Hex}) is “AF”. Hence, the content of the reception memory 2 can be referenced as follows by indicating the address of the respective memory cell 21: the content of the reception memory 2 at the address 00_{Hex} is “FF”, at the address 01_{Hex} is “FA”, at the address 10_{Hex} is “AF”, at the address 11_{Hex} is “3E”, etc. In this case, this referencing refers to memory cells 21 with a size of one byte. It is known that two or more bytes can be combined into one stored word (2 bytes), into one stored long word (4 bytes) etc. The content of the stored word at the address 00_{Hex} in the reception memory area 2 is thus “FF FA”, and the content of the stored word at the address 10_{Hex} is accordingly “AF 3E”.

The match between the content of a memory cell 21 and a comparison value is a condition whose satisfaction—or accordingly whose nonsatisfaction—needs to be ascertained by a user.

FIG. 2b shows a second illustration of the reception memory 2. In line with this illustration, the first two memory cells 21 (two memory cells=2 bytes=1 word) are provided for storing the receiver identifier 11 from a received telegram 10 copied to the reception memory area 2. A further two memory cells 21 are provided for storing the sender identifier 12 from the telegram 10 and the subsequent memory cells 21 are provided for storing the user data 13 from the telegram 10.

It is thus now possible to formulate a condition which can be used to check whether a particular communicating party 1 has received a telegram 10 in which a particular data item deviates from a predetermined, e.g. an expected, value.

In natural language, such a condition could be expressed as follows:

{IF}

[the content of the reception memory area 2 at the
address 04_{Hex} (read as a word)]
{corresponds to}
[an identifier for the communicating party 1 whose
transmissions are to be monitored],
{AND}
[the content of the reception memory area at the
address 08_{Hex}]
{does not correspond to}
[a prescribed comparison value],

{THEN} [....].

The condition used by way of example comprises two separate operations: the first operation (from IF to AND) is used to ascertain whether the telegram 10 has originated from a particular sender (communicating party) 1. The second operation (from AND to THEN) is used to ascertain whether a particular location (position/address) in the transmitted user data 13 deviates from a predetermined value. Both operations are “binary operations” which are represented by a “condition block” 30.

FIG. 3 shows such a condition block 30. The condition block 30 comprises an operation area 31 for holding a prescribable operation 31 and comprises a first and a second action area 32, 33 for holding a prescribable first or second action 32, 33. Since the operation area 31 stores an operation 31 and the action area 32, 33 stores actions 32, 33, the terms operation 31 and operation area 31 and also action 32, 33 and action area 32, 33 are used synonymously.

The operation area 31 comprises positions 34 to 37 for holding an address 34, a masking value 35, a comparison operator 36 and a comparison value 37. In the text below, the position and its content, that is to say, by way of example, the position 34 for holding an address and the address 34 itself, are again referred to synonymously.

Since the operation 31 formulated using a condition block 30 comprises a comparison operator 36 as operator 36, the operation 31 is accordingly a comparison operation 31. A comparison operation 31 is an operation which always delivers one of two possible results ([satisfied, not satisfied]; [true, false]; [yes, no]; etc.). The comparison operation 31 is thus a condition which is either “true” or “false”, “satisfied” or “not satisfied”, etc. Accordingly, the terms operation and condition are also used synonymously.

To evaluate the result of the comparison operation 31, the first and second action areas 32, 33 are provided. In this context, the first action area 32 is associated with the first of the two possible results of the comparison operation 31, and the second action area 33 is associated with the second of the two possible results of the comparison operation 31. Each action area 32, 33 comprises a secondary action area 38, 38′ and a combinational logic reference 39, 39′, the secondary action area 38, 38′ and a secondary action 38, 38′ stored therein again being referred to synonymously.

In the case of a first result—e.g. “satisfied”—the first secondary action 38, stored in the secondary action area 38 in the first action area 32, is performed. Accordingly, in the case of a second result—e.g. “not satisfied”—the second secondary action 38′, stored in the secondary action area 38′ in the second action area 33, is performed. The secondary action area 38, 38′ stores either the respective secondary action 38, 38′ itself or a reference to the storage location thereof (the start address thereof).

Suitable secondary actions 38, 38′ are, by way of example, the incrementing or decrementing of a counter. If the first secondary action 38 provided is the incrementing of a first counter and the second secondary action 38′ provided is the incrementing of a second counter, evaluation of the respective counter readings can be used to ascertain how often a condition was satisfied or not satisfied. In addition, suitable secondary actions 38, 38′ are, by way of example, the initiation of an interrupt, which means that it is possible to react as quickly as possible to the circumstance that a condition is satisfied or is not satisfied. Finally, suitable secondary reactions 38, 38′ are also, by way of example, a data item in the reception memory 2 being set to a first value if a condition is satisfied and being set to a second value if a condition is not satisfied, or a first data item in the reception memory 2 being set to a prescribed value if a condition is satisfied and a second data item being set to the same or to another value if a condition is not satisfied. This allows later evaluation of the results of the condition by that software/application which performs the actual evaluation of the reception memory 2.

Each action area 32, 33 comprises a respective combinational logic reference 39, 39′. The combinational logic reference 39, 39′ is used for logically combining a condition block 30 with a further condition block 30. The combinational logic reference 39, 39′ is, by way of example, the address of the further condition block or the index number of the further condition block 30 if a particular, maximum number of condition blocks 30 is provided and hence each condition block can be referenced using a unique index number. The combinational logic reference 39, 39′ is an output for the condition block 30, as it were. The secondary actions 38, 38′ and combinational logic references 39, 39′ can be used independently of one another. Evaluation of a condition 31 can thus be followed by execution of a secondary action 38, 38′ and—using the combinational logic reference 39, 39′—processing of a further condition block 30. Alternatively, it is also possible for a secondary action 38, 38′ not to be performed after evaluation of the current condition 31 and for the processing of a further condition block 30 specified using the combinational logic reference 39, 39′ to be continued directly. Finally, it is also possible for no logic combination with a further condition block 30 to be provided and for just one secondary action 38, 38′ to be performed.

If the combinational logic reference 39, 39′ is not being used, this means that there is no logic combination, and the current condition block 30 is not followed by a further condition block 30. Instead of an unused combinational logic reference 39, 39′, a unique, prescribed value—e.g. “0”—for the combinational logic reference 39, 39′ can also mean that the current condition block 30 is not followed by a further condition block 30.

Logically combining a plurality of condition blocks 30 permits the formulation of complex expressions which are composed of individual operations or conditions, each individual condition being coded by a separate condition block 30.

To distinguish between the terms condition/operation and expression, the present text treats the term expression within the context of composed operations/conditions. Accordingly, an expression comprises one or more operations/conditions, since each condition block 30 uses its operation part 31 to code precisely one operation/condition. In the case of an expression whose coding requires just one condition block 30, the expression corresponds to the single condition.

FIG. 4 shows two logically combined condition blocks 30 which are used to illustrate the formulation of an expression for checking whether a particular communicating party 1 has sent a particular data item, using the condition blocks 30. The expression comprises two operations, the first operation relating to the particular communicating party 1 and the second operation relating to the particular data item. Accordingly, formulation of the expression requires two condition blocks 30, the first condition block 30 (the top one in FIG. 4) being used to code the operation relating to the communicating party 1, and the second condition block 30 (the bottom one in FIG. 4) being used to code the operation relating to the data item.

First, a pseudocode resembling the programming language PASCAL is used to explain evaluation of an expression formulated by one or more condition blocks 30, the line numbers indicated on the left being used to refer to individual instructions/steps.

| | |
|---|---|
| 100 | FUNCTION ConditionBlock(address : word; |

mask : word;
operator : byte;
operand2 : word) : boolean;

| | | |
|---|---|---|
| 101 | VAR | operand1 : word; |

| | |
|---|---|
| 102 | BEGIN |

| | |
|---|---|
| 103 | operand1 : = reception memory 2 [address]; |
| 104 | operand1 : = operand1 AND mask; |
| 105 | CASE operator OF |

| | | |
|---|---|---|
| 106 | 01: | IF (operand1 = operand2) THEN |

| | |
|---|---|
| 107 | ConditionBlock : = TRUE |

| | |
|---|---|
| 108 | ELSE |

| | |
|---|---|
| 109 | ConditionBlock : = FALSE ; |

| | | |
|---|---|---|
| 110 | 02: | IF (operand1 < > operand2) THEN |

| | |
|---|---|
| 111 | ConditionBlock : = TRUE |

| | |
|---|---|
| 112 | ELSE |

| | |
|---|---|
| 113 | ConditionBlock : = FALSE; |

| | | |
|---|---|---|
| 114 | 03: | IF (operand1 < operand2) THEN |

| | |
|---|---|
| 115 | ConditionBlock : = TRUE |

| | |
|---|---|
| 116 | ELSE |

| | |
|---|---|
| 117 | ConditionBlock : = FALSE ; |

| | | |
|---|---|---|
| 118 | 04: | IF (operand1 > operand2) THEN |

| | |
|---|---|
| 119 | ... |
| 130 | |

| | |
|---|---|
| 149 | END CASE ; |

| | |
|---|---|
| 150 | END FUNCTION ; |

Lines 100 to 150 indicate one possible algorithm for implementing a condition block 30. In line 100, FUNCTION is used to initiate a subprogram which is referred to as “ConditionBlock” for reasons of legibility and is supplied with the parameters “address”, “mask”, “operator” and “operand2”. In accordance with the internal algorithm, the subprogram returns a value of “boolean” type ([true, false] etc.). Transfer of the parameters and, in particular, which data/values are transmitted as parameters are explained further below in connection with calling of the subprogram.

The type of comparison operation to be executed by the condition block 30 is prescribed for the subprogram using the parameter “operator”. The second operand for the comparison operation is prescribed using the parameter “operand2”. The first operand for the comparison operation is determined within the subprogram. To this end, the local variable “operand1” is declared in line 101. In line 103, this variable is assigned the content of the reception memory 2 at the address/position prescribed by the parameter “address”. Next, the value of this variable is logically ANDed with the value of the parameter “mask” in line 104 (the first operand is “masked”). Hence, besides the second operand, which had been transferred as the parameter “operand2”, the first operand is now also available for further use in the variable “operand1”.

In line 105, a case distinction is started in accordance with the operator transferred as the parameter “operator”. This purportedly involves a numerical assignment being made such that a value “01” for the parameter “operator” codes a comparison operation with regard to identity, a value “02” for the parameter [lacuna] codes a comparison operation with regard to inequality, etc. Thus, if the transferred operator denotes an operation for comparison with regard to identity (“==”), then execution branches to line 106. If the transferred operator denotes an operation for comparison with regard to inequality (“!=”), then execution branches to line 110, etc.

To continue the explanation, it is assumed that the parameter “operator” has been used to prescribe an operator for comparison with regard to inequality and that execution has accordingly branched to line 110. In line 110, this operator is expressed as “<>” (not equal to) within the IF instruction in accordance with the rules of the programming language. If the value of the variable “operand138 is not equal to the value of the parameter “operand2”, then execution branches to line 111, otherwise execution branches to line 113. In the event of a branch to line 111, the subprogram's return value is set to the value “TRUE” (the two operands were actually not equal when inequality was to be checked), and in the event of a branch to line 113, it is set to the value “FALSE” (the two operands were actually equal when inequality was to be checked).

Once the last line of an alternative for the case distinction initiated in line 105 has been reached, execution jumps to the end of the case distinction in line 149, and the subprogram is continued at this point. The subprogram then ends in line 150 and the subprogram's return value ascertained previously (e.g. in line 111 or line 113) is returned.

As can be seen from the pseudocode, other operators, such as equality (“==”; lines 106 to 109) or less than (“<”; lines 114 to 117) are evaluated in a similar manner to the evaluation described. The pseudocode therefore also no longer explicitly contains the otherwise necessary further alternatives for the case distinction.

Instead of the masking by means of ANDing in line 104, another logic function, e.g. OR or XOR, can be provided. In addition, provision can be made for the combinational logic operator for the masking to be transferred as a parameter in the same way as illustrated above for the parameter “operator”. Instead of the firmly prescribed logic combination, as is now indicated in line 104, an additional case distinction in the form of lines 105 to 149 would then need to be inserted.

Lines 200 to 214 below are used to explain the processing of a plurality of connected condition blocks 30.

| | |
|---|---|
| 200 | IF (test active = TRUE) THEN BEGIN |

| | |
|---|---|
| 201 | Pointer to condition block 30 : = address of |
| | the first condition block 30; |
| 202 | WHILE NOT (pointer to condition block 30 = 0) |
| | BEGIN |

| | |
|---|---|
| 203 | CASE ConditionBlock (address 34, |

masking value 35,
comparison operator 36,
comparison value 37) OF

| | |
|---|---|
| 204 | TRUE: BEGIN |

| | |
|---|---|
| 205 | Perform secondary action 38 of |
| | the current condition block 30; |
| 206 | Pointer to condition block 30: = |
| | combinational logic reference |
| | 39; |
| 207 | END; |

| | |
|---|---|
| 208 | FALSE: BEGIN |

| | |
|---|---|
| 209 | Perform secondary action 38′ of |
| | the current condition block 30; |
| 210 | Pointer to condition block 30: = |
| | combinational logic reference |
| | 39′; |
| 211 | END ; |

| | |
|---|---|
| 212 | END CASE ; |

| | |
|---|---|
| 213 | END WHILE ; |

| | |
|---|---|
| 214 | END IF ; |

In line 200, this first involves testing whether processing or evaluation of a condition block 30 or of a series of condition blocks 30 is actually provided or is currently deactivated. This is done by checking the status of the flag “test active”, with the condition being satisfied and processing being continued in line 201 only if the flag is set.

In line 201, the variable “pointer to condition block” is assigned that address at which the first condition block 30 is stored in the memory 3. This variable is used in line 202 in order to formulate a condition for a repeat instruction (WHILE loop) which is satisfied for as long as the condition blocks 30 need to be evaluated. If the pseudocode contains terms, such as “condition block”, which are also used in the rest of the description, these terms are printed in italics, and the appropriate reference is indicated in order to simplify assignability.

If provision is made for one or more condition blocks to be evaluated, at least one condition block 30 is defined, so that the condition is satisfied and processing is continued in line 203. Should no condition block 30 have been defined upon activated evaluation, the check in line 202 is a security check. This prompts processing to be continued in line 213 and therefore causes evaluation to be skipped completely.

If at least one first condition block 30 has been defined, the condition in line 202 is satisfied and the case distinction formulated in line 203 is initiated. This case distinction is dependent on the return value from the subprogram “ConditionBlock”; cf. lines 100 to 150 in the first pseudocode fragment. This described the fact that the subprogram “ConditionBlock” returns either the return value “TRUE” or the return value “FALSE”, depending on whether or not the comparison operation 31 formulated with the respective condition block 30 had been satisfied. The only two possible alternatives for the case distinction are thus “TRUE” and “FALSE”. Accordingly, processing is continued in line 204 if the comparison operation 31 for the current condition block 30 is satisfied, or is continued in line 208 if the comparison operation 31 is not satisfied.

If the comparison operation 31 has been satisfied, the first secondary action 38 stipulated in the action area 32 is performed in accordance with line 205. Next, the variable “pointer to condition block” is assigned the value of the first combinational logic reference 39 for the current condition block 30 in line 206. With a plurality of logically combined condition blocks 30, this initiates advancement to the next condition block 30. If the current condition block 30 is not succeeded by a further condition block, this is indicated by a corresponding value for the combinational logic reference 39, e.g. “0”. If the current condition block 30 is succeeded by a condition block, then its address is stored as the combinational logic reference 39. When line 206 has been processed, the variable “pointer to condition block” thus has either the value zero or a value which is different than zero. With this prerequisite, processing is continued in line 202, having passed by lines 212, 213. If the value of the variable “pointer to condition block” is now equal to zero, then the condition in line 202 is not satisfied, and evaluation has been ended. If the value of the variable “pointer to condition block” is different than zero, on the other hand, then the next condition block 30 specified thereby is evaluated.

In a similar manner to when the comparison operation 31 is satisfied, in the event of the comparison operation 31 not being satisfied the processing is first continued in line 209, where the second secondary action 38′ starts to be executed. Subsequently, the variable “pointer to condition block” is assigned the value of the second combinational logic reference 39′ in line 210.

The condition block 30 or its action area 32 stores either the secondary action 38, 38′ itself or else its start address in the memory 3. A secondary action 38, 38′ which may still be able to be stored in the condition block 30 can relate, by way of example, to the incrementing or decrementing of a counter or to the initiation of an interrupt. Within the context of a more complex secondary action 38, 38′ than this, the condition block 30 itself stores only said 'secondary action's start address, which can be used to call the secondary action 38, 38′ directly, for reasons of efficiency. However, the general case is either storage of the respective start address for every possible secondary action 38, 38′ or else storage of an index number for referencing a prescribed secondary action 38, 38′ (e.g.: 1: incremented counter 1, 2: decremented counter 1, etc.). The reason for this is that it is then possible to use a random data type for implementing the condition block 30 in software. When the subprogram “ConditionBlock” is called in line 203, the parameters transferred for the subprogram are the address 34, the masking value 35, the comparison operator 36 and the comparison value 37. These parameters are stored together in the operation area 31 of the respective condition block 30. For reasons of clarity, the use of the variable “pointer to condition block” has not been shown in full in the pseudocode. So that, by way of example, the parameters transferred for the subprogram “ConditionBlock” are always the values of the operation area 31 in the currently evaluated condition block 30, the full first parameter in line 203 would—in a resemblance to the notation of the programming language PASCAL—have to be, by way of example: >>pointer to condition block\hat{ }.Address<<. A similar situation applies for the other parameters. In PASCAL, notation in the form >>WITH pointer to condition block\hat{ } DO CASE ConditionBlock (address 34, . . . ) OF<<is then also permitted, which again allows the parameter list to be shortened. This applies in a similar manner to the instructions or operations in lines 205, 206 and 209, 210 as well.

Against this background, evaluation of the two condition blocks 30 shown in FIG. 4 is described below. In this context, a link to the pseudocode is provided by indicating its respective relevant lines in square brackets—[, ] . First [line 200] , the premise is made that evaluation of the condition blocks has been activated. The first condition block 30—the top one in FIG. 4—is then selected [line 201].

When the subprogram “ConditionBlock” is called [line 203] , the parameters transferred are the value “4” for the address 34, the value “FF 00” for the masking value 35, the value “01” for the comparison operator 36, and the value “3D 00” for the comparison value 37. These values are used to process the subprogram

“ConditionBlock” [lines 100-150]. This first [line 103] involves the variable “operand138 being assigned the content of the reception memory 2 at the address 4. FIG. 2a shows that the content of the reception memory 2 at the address 4 has been read “3D F4” as a word (2 bytes). The value of the variable “operand138 is thus accordingly “3D F4”. This value is now logically ANDed with the value of the parameter “mask” [line 104]. The value of the parameter “mask” was “FF 00”, which means that the variable “operand138 has the value “3D 00” after masking [line 104].

Depending on the value of the parameter “operator”, a case distinction [line 105] is then made in order to evaluate the respective coded comparison operation. In this case, the parameter transferred was the value “01”, which is intended to code a comparison operation with regard to identity the following the assignment. Written with the variable “operand1” and the parameter “operand2”, the comparison operation is then: >>(3D 00=3D 00)<<[line 106]. This operation is true, which means that the subprogram's return value is set accordingly [line 107 ].

The subprogram's return value “TRUE” is now used to branch to the alternative for the satisfied comparison operation [lines 204 to 207]. The first provision made here is execution of the first secondary action 38 [line 205]. However, the address prescribed for the first secondary action 38 is the value “00 00”, which is equivalent to the circumstance of no secondary action being provided.

The pointer is then advanced to the condition block by loading the value of the first combinational logic reference 39 into the corresponding variable [line 2061. The first combinational logic reference has the value “00 A0”, and it will be assumed that the second condition block 30—the bottom one in FIG. 4—is stored at the position “00 A0” in the memory 3, which means that the first combinational logic reference 39 is used to set up the desired logic combination.

The evaluation of the first condition block 30 is thus complete, and accordingly the first pass through the evaluation loop [lines 202 to 213] has ended. The new value “00 0A” of the variable “pointer to condition block” is used to test whether the condition for entry into the loop [line 202] is still satisfied. The value “00 0A” is not equal to “0”, that is to say the subprogram “ConditionBlock” is called again using the values stored in the now current (second, bottom) condition block 30 [line 203].

The value for the parameter “address 34” is “8”, that for the masking value 35 is “FF FF”, that for the comparison operator 36 is “02”, and that for the comparison value 37 is “AB CD”. These values are used for fresh processing of the subprogram “ConditionBlock” [lines 100 to 150]. The content of the reception memory 2 at the address “8” is “B2 B16” (cf. FIG. 2a). This value is assigned to the variable “operand138 [line 103] and is ANDed with “FF FF” [line 104], so that the value of the variable remains unchanged. The case distinction means that the value “02” of the parameter “operator” is used to select the corresponding comparison operation. Written with the variable “operand138 and the parameter “operand2”, this is then >>(B2 16<>AB CD)<<[line 110]. This operation is true, which means that the subprogram's return value is set accordingly [line 111].

The subprogram's return value “TRUE” is now used to branch to the alternative for the satisfied comparison operation again [lines 204 to 207}. Here, the first provision made is again performance of the first secondary action 38 [line 205]. The address specified for the first secondary action 38 is the value “0C 00”. The first secondary action 38 is performed by executing a subprogram starting at the address “0C 00” in the memory 3. The pointer is then advanced to the condition block by loading the value of the first combinational logic reference 39 into the corresponding variable [line 206]. The first combinational logic reference has the value “00 00”, which is equivalent to the circumstance that no further condition block follows.

The evaluation of the second condition block 30 is thus likewise complete, and accordingly the second pass through the evaluation loop [lines 202 to 213] has ended. The new value “00 00” of the variable “pointer to condition block” is used to test whether the condition for entry into the loop [line 202] is still satisfied. This time, the value “00 00” is equal to “0”, which means that the algorithm for evaluating the condition blocks 30 indicated in FIG. 4 has ended.

The evaluation of the two condition blocks 30 shown in FIG. 4 thus corresponds to processing of the expression formulated further above by way of example for the purpose of checking whether a particular data item within the transmitted user data 13 from a particular sender 1 deviates from a predetermined, e.g. expected, value.

The first of the two connected condition blocks 30 is used to ensure identification of the particular sender 1, because the data transferred to the reception memory 2 are examined from the address “4” in the reception memory 2, the memory location for the transmitter identifier 12. The next condition block 30 is then used to examine the user data 13, because the reception memory is examined at the address “8”, the first position for the user data 13.

The two pseudocode fragments described are one example of formulation of the evaluation routine 4. This shows that the evaluation routine 4 is invariable in the case of the specific formulation chosen, despite the opportunity to evaluate a wide variety of operations. This allows the evaluation routine 4 to be implemented using an ASIC or an FPGA, for example, which means that the evaluation routine 4 is then hard-coded. Hardcoding of the evaluation routine 4 prompts accelerated execution, which means that the respective operations/conditions can be evaluated in real time.

The method for operating a programmable control device is thus distinguished in that, at the time at which the program 8 in the control device 1 is executed, comparison operations 31 can be formulated which can be evaluated by an evaluation routine 4. Depending on the result of the respective comparison operation 31, actions 32, 33 are initiated which can likewise be formulated during the runtime of the program 8, which means that it is possible to diagnose and/or to monitor the control device 1 without interrupting its operation.

1. A method for operating a programmable control device (1) which has a memory (3) and a processor unit (7),
where the memory (3) stores an evaluation routine (4) which can be executed by the processing unit (7) and, independently of said evaluation routine, an operand (34), a comparison operator (36) and a comparison value (37),
where the operand (34), the comparison value (37) and the comparison operator (36) form a binary comparison operation (31) which delivers either a first or a second result and which have associated first and second actions (32, 33), and
where executing the evaluation routine (4) involves evaluation of the binary comparison operation (31) and, on the basis of the result of the binary comparison operation (31), performance of either the first or the second action (32, 33).

2. The method as claimed in claim 1, where the memory (3) stores a masking value (35), and the operand (34) and the masking value (35) are operands for a masking operation using a masking operator, the result of said masking operation forming the binary comparison operation (31) together with the comparison value (37) and the comparison operator (36).

3. The method as claimed in claim 1, where the comparison operation (31) is coded by the content (34, 36, 37) of a respective operation area (31) which is stored in the memory (3) and comprises at least the operand (34), the comparison value (37) and the comparison operator (36).

4. The method as claimed in claim 2, where the comparison operation (31) is coded by the content (34, 35, 36, 37) of a respective operation area (31) which is stored in the memory (3) and comprises at least the operand (34), the masking value (35), the comparison value (37) and the comparison operator (36).

5. The method as claimed in claim 1, where each action (32, 33) is coded by the content (38, 38′, 39, 39′) of a first and a second action area (32, 33) respectively stored in the memory (3), and where each action area (32, 33) comprises either
a secondary action (38, 38′) or
a combinational logic reference (39, 39′) or
a secondary action (38, 38′) and a combinational logic reference (39, 39′).

6. The method as claimed in one of claims 3 to 5, where the operation area (31) and the first and second action areas (32, 33) form a condition block (30) in the memory (3).

7. The method as claimed in claim 6, where each action (32, 33) has a respective associated combinational logic reference (39, 39′) which is suitable for referencing a condition block (30) by indicating the corresponding address in the memory (3), and the action (32, 33) comprises evaluation of the combinational logic reference (39, 39′).

8. The method as claimed in claim 1, where each action (32, 33) has a respective associated secondary action (38, 38′), and the action (32, 33) comprises initiation of the secondary action (38, 38′).

9. The method as claimed in claim 8, where initiation of the secondary action (38, 38′) comprises execution of a routine stored in the memory (3) from the start address (38, 38′) indicated as the secondary action (38, 38′).

10. The method as claimed in one of claims 7 to 9, where the first or the second action (32, 33) comprises both initiation of the secondary action (38, 38′) and evaluation of the combinational logic reference (39, 39′).

11. The method as claimed in claim 1, where the control device (1) has a bus port (6) for connection to a bus (5) and is suitable for receiving a telegram (10) via the bus (5), where reception of a telegram (10) involves at least one data area (13) of the telegram (10) being copied to a reception memory (2) in the memory (3), and where the operand (34) is an element of the reception memory (2) or denotes a position in the reception memory (2).

12. The method as claimed in claim 1, where the evaluation routine (4) is hard-coded.
